(19) United States
(12) Patent Application Publication
(10) Pub. No.: US 2026/0365938 A1
(43) Pub. Date: Nov. 19, 2026

(54) PROCESS FOR PRODUCING A PALM OIL FRACTION

(71) Applicant: Cargill, incorporated, Wayzata, MN (US)

(72) Inventors: Kim Leong CHUA, PORT KLANG (MY); Mohamad Shahdan HASSAN, Port Klang (MY); Mohamad Asfa HIRULDIN, Port Klang (MY); Chin Woon HO, Port Klang (MY); Pei Yin TAY, PORT KLANG (MY)

(73) Assignee: Cargill, incorporated, Wayzata, MN (US)

(21) Appl. No.: 19/155,350

(22) PCT Filed: Feb. 23, 2024
(86) PCT No.: PCT/US2024/017003

§ 371 Date: Aug. 11, 2025

(30) Foreign Application Priority Data
Feb. 23, 2023 (EP) 23158247.9

(51) Int. Cl. C11B 7/00

(52) U.S. Cl. CPC C11B 7/0025; C11B 7/0075

(57) ABSTRACT

The present disclosure relates to a process for producing a palm oil product comprising the following steps of: (a) solidifying palm oil starting material in the presence of a solvent and obtaining a mixture comprising solvent and solids of palm oil starting material; (b) partially re-melting the mixture obtained in step (a); (c) solidifying the mixture obtained in step (b); and (d) separating the mixture obtained in step (c) into a solid fraction and a liquid fraction as described in the claims.

### CROSS-REFERENCE TO RELATED APPLICATIONS

This application claims the benefit of European Patent Application No. 23158247.9, filed 23 Feb. 2023, which is incorporated by reference herein in its entirety.

### FILED OF THE INVENTION

The present invention relates to a novel fractionation process for producing a palm oil product from a palm oil starting material.

### BACKGROUND

Cocoa butter equivalents (CBEs), which have been commonly used in replacement of cocoa butter in chocolate making, are generally produced from mixture of exotic fats and hard PMF (PMF=palm mid fraction). However, the production of hard PMF usually involves several fractionation steps.

Hard PMF is generally produced via fractionation of palm oil. Fractionation is primarily a separation process in which fat is solidified and subsequently separated from the liquid phase. There are three common types of fractionations, namely dry fractionation, solvent fractionation, and detergent fractionation. Solvent fractionation involves the addition of solvent to oil to promote crystallization and followed by separation via filtration into a liquid fraction, also called an olein fraction, and a solid fraction, also called a stearin fraction. Higher separation efficiency can be achieved as compared to when solvents are not used. Crystallization during solvent fractionation is commonly carried out via scraped surface heat exchanger process or in a batch crystallizer cooled by vacuum-evaporation of solvent.

Process in the art discloses that hard PMF can be produced from palm olein (IV 56) using three steps of dry fractionation, with or without ultrasound assisted, or two steps of solvent fractionation, or a combination of two dry fractionation steps and one solvent fractionation step.

With multiple fractionation process steps (as is the case for the traditional fractionation processes to obtain hard PMF), multiple co-fractions are generated that require a useful outlet. Multiple number of storage tanks are required for storage of intermediate products and co-fractions, which requires higher investment cost. In every fractionation process steps oil loss happens which may result in lesser yields. In addition, the described processes in the art, involving multiple fractionations, require a longer process time and higher energy consumption.

Hence, there remains improvement for fractionation process of hard PMF with less fractionation process step, less side fractions, less consumption of solvent, less consumption of energy to produce desirable product quality and/or relatively high yield.

### SUMMARY

The present disclosure provides a process for producing a palm oil product that comprises the steps of: (a) solidifying a palm oil starting material in the presence of a solvent and obtaining a mixture comprising solvent and solids of the palm oil starting material; (b) partially re-melting the mixture obtained in step (a); (c) solidifying the mixture obtained in step (b); and (d) separating the mixture obtained in step (c) into a solid fraction and a liquid fraction, wherein after the solidification step a) the slurry of solids of the partially solidified mixture from step a) is at a temperature range of the mixture obtained in step a) is from 7 to 12 °C; after partially re-melting, the mixture obtained in step (b) is at a the temperature range of the mixture obtained in step b) is from 10 to 16 °C; after solidification, the mixture obtained in step c) is at a temperature range of the mixture obtained in step c) is from 5 to 10 °C. The palm oil starting material is palm oil or palm oil fraction.

### DETAILED DESCRIPTION

Reference will now be made in detail to certain aspects of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Unless defined otherwise, all technical and scientific terms used herein have the same meaning as commonly understood by one skilled in the art to which this invention belongs. As used herein, each of the following terms has the meaning associated with it as defined below.

Unless expressly stated, ppm (parts per million), percentage, and ratios are on a by weight basis. Percentage on a by weight basis is also referred to as wt. % below.

The term “for example,” “for instance,” “such as,” or “including” as used herein is meant to introduce examples that further clarify more general subject matter. Unless otherwise specified, these examples are provided only as an aid for understanding the applications illustrated in the present disclosure and are not meant to be limiting in any fashion.

In the methods described herein, the acts can be carried out in any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

### Method for Producing a Palm Oil Product

The present disclosure relates to a process for producing a palm oil product, comprising the steps of:
(a) solidifying a palm oil starting material in the presence of a solvent and obtaining a mixture comprising solvent and solids of the palm oil starting material;
(b) partially re-melting the mixture obtained in step (a);
(c) solidifying the mixture obtained in step (b); and
(d) separating the mixture obtained in step (c) into a solid fraction and a liquid fraction wherein
   after the solidification step a) the slurry of solids of the partially solidified mixture from step a) is at a temperature range of the mixture obtained in step a) is from 7 to 12 °C; after partially re-melting, the mixture obtained in step (b) is at a the temperature range of the mixture obtained in step b) is from 10 to 16 °C;
   after solidification, the mixture obtained in step c) is at a temperature range of the mixture obtained in step c) is from 5 to 10 °C.
      Step (a)—Solidifying Palm Oil Starting Material in the Presence of a Solvent and Obtaining a Mixture Comprising Solvent and Solids of Palm Oil Starting Material

To start with the process, a palm oil starting material is first mixed with a solvent. The mixture of solvent and the palm oil starting material is cooled to solidify and partially crystallize the palm oil starting material. A mixture comprising solvent and solids of partially crystallized palm oil starting material (partially crystallized solid-solvent mixture) is thus obtained.

“Palm oil starting material” or “starting material”, as used herein, refers to palm oil or any oil and/or fat that has been obtained from palm oil by means of fractionation, interesterification, and/or hydrogenation. The palm oil starting material may have an iodine value (IV) of from 35 to 65, or more preferably, an IV of from 50 to 60. Preferably, the palm oil starting material, is palm oil, a palm oil fraction, interesterified palm oil, interesterified palm oil fraction, hydrogenated palm oil, hydrogenated palm oil fraction or a combination of two or more thereof, wherein each time the term “fraction” is referring to palm olein, palm stearin or soft palm mid fraction. More preferably, the palm oil starting material is selected from the group consisting of palm oil, palm olein, interesterified palm oil, interesterified palm olein, interesterified palm oil stearin, and combinations of two or more thereof. Most preferably, the palm oil starting material is palm oil, palm olein or combinations thereof. In a preferred aspect of the invention, the palm oil starting material is palm olein.

In a preferred aspect, the palm oil starting material used for the process of the present invention is a refined, bleached and/or deodorized oil. Most preferably, the palm oil starting material is an RBD oil, i.e. a refined, bleached and deodorized oil.

The terms “solidifying”, “solidification” as used in the present invention are encompassing crystallization as well as any process whereby acylglycerides are completely or partially transitioning from liquid into solid form. Said solid acylglycerides can be in crystalline and/or amorphous form. Furthermore, the term “partial solidification” or “partially solidified” relates to a process or mixtures respectively, wherein acylglycerides are present in solid form as well as and in liquid form.

In a preferred aspect, the palm olein used for the process has an IV of from 55 to 58, preferably of 56 (hereafter called “palm olein IV56”). Furthermore, the palm olein may have a solid fat content (SFC), measured according to standard method of IUPAC 2.150a, as shown in Table 1 and a triglyceride composition comprising the triglycerides as shown in Table 2.

TABLE 1

| Solid Fat Content | |
|---|---|
| according to IUPAC method 2.150a | Weight % |
| N10 | 25-35; preferably 31 |
| N20 | 2-8; preferably 4 |
| N25 | Maximum 2; |
| | preferably 0 |

TABLE 2

| Triglyceride content | |
|---|---|
| according to AOCS Ce5-86 method | Weight % |
| Tripalmitoylglycerol (PPP) | Maximum 2; preferably 1 |
| 1,3-dipalmitoyl-2-oleoyl-glycerol (POP) | 25-40; preferably 31 |
| 1,2-dioleoyl-3-palmitoyl-glycerol (POO) | 20-35; preferably 26 |

Solvent may be mixed with the palm oil starting material in a ratio of palm oil starting material/solvent in a range of from 1/4 to 1/0.5, from 1/3 to 1/0.75, such as 1/1 or 1/2 (for example a palm oil starting material/solvent of 1/4 being a mixture of 1 part palm oil starting material and 4 parts solvent). Examples of solvent include, but are not limited to, acetone, hexane, heptane, isopropyl alcohol, methanol, or a combination of two or more thereof. Preferably, the solvent is acetone.

Preferably, the solidification of the mixture of solvent and palm oil starting material can be done by cooling. In a preferred aspect, cooling can be done in a batch crystallizer that is cooled by vacuum-evaporation of solvent at a pressure in a range of from 125 to 600 mbar. Preferably, the pressure can be reduced in three stages: in the first stage, the pressure is reduced to between 400 and 600 mbar; in the second stage, the pressure is reduced to between 100 and 300 mbar; and in the final stage, the pressure is reduced to between 120 and 150 mbar.

In another preferred aspect, cooling can be done in a double jacketed cooling vessel with scraped surface (also known as scraped surface heat exchanger) or without scraped surface.

In the partially solidified mixture from step a), solid fat may be present in an amount from 12 to 70 wt. %, from 20 to 60 wt. %, or from 30 to 50 wt. % based on the total weight of the palm oil starting material (i.e., not including the weight of the solvent). Furthermore, the partially solidified mixture from step a) also contains liquid oil, i.e oil from the palm oil starting material that was not solidified in step a) of the process. In a preferred aspect, when palm olein IV56 is used as the palm oil starting material, the amount of solid fat present in the partially solidified mixture from step a) is from 15 to 60 wt. %, preferably from 20 to 50 wt. %, more preferably from 30 to 40 wt. % based on the total weight of palm oil IV56 (i.e., not including the weight of the solvent), most preferably from 35 to 40 wt %.

After the solidification step a), the slurry of solids of the partially solidified mixture from step a) is at a temperature of from 7 to 12 °C, from 8 to 11 °C, or from 8.5 to 10.5 °C.

Step (b)—Partially Re-Melting the Mixture Obtained in Step (a)

The partially solidified mixture obtained in step (a) is heated in step (b) to partially re-melt the solids.

Partially re-melting can be expressed as the reduction of solids present in the mixture at the end of step (b) as compared to the amount of solids present in the mixture at the end of step (a). The solids content of the mixture at the end of step (b) may be reduced by a range of from 40 to 80%, from 50 to 75%, or preferably from 55 to 70% as compared to the amount of solids present in the mixture at the end of step (a) due to remelting in step b). As mentioned before, in the partially solidified mixture from step a), solid fat may be present in an amount from 12 to 70 wt. %, from 20 to 60 wt. %, or from 30 to 50 wt. % based on the total weight of the palm oil starting material. Therefore, in the mixture obtained at the end of step (b), the actual content of solids present is from 2.4 to 42 wt. % (corresponding to 12-70% times 20-60%, which is the remaining portion of solids left after reduction of the solids with 40 to 80%), from 5 to 30 wt. %, or 9 to 22.5 wt. % based on the total weight of the palm oil starting material (i.e., not including the weight of the solvent). In a preferred aspect, when palm olein IV56 is used as the palm oil starting material, the amount of solids present in the mixture obtained at the end of step (b) is from 3 to 36 wt. % (corresponding to 15-60% times 20-60%, which is the remaining portion of solids left after reduction of the solids with 40 to 80%), from 5 to 25 wt. %, or from 9 to 18 wt. % based on the total weight of palm oil IV56 (i.e., not including the weight of the solvent).

Re-melting in step b) may be done by heating up of the mixture obtained in step a). In a preferred aspect heating up the mixture obtained in step a) is done by adding hot solvent, preferably at a temperature of from 30 °C to 35 °C. Solvent may be added to maintain a ratio of palm oil starting material/solvent in a range of from 1/4 to 1/0.5, from 1/3 to 1/0.75, such as 1/1 or 1/2.

In an alternative preferred aspect, heating up of the mixture obtained in step a) may be done by means of a double jacketed heating from the vessel wherein the mixture is held and/or a heating coil.

After partially re-melting, the mixture obtained in step (b) is at a temperature of from 10 to 16 °C, from 11 to 15 °C, or from 12 to 14 °C.

Temperature difference between the mixture obtained in step (b) and the mixture obtained in step (a) can be in a range of from 0.5 to 10 °C, from 3 to 8 °C, or from 4 to 6 °C. In a preferred aspect, when palm olein IV56 is used as the palm oil starting material, the temperature difference can be in a range of from 0.5 to 7 °C, from 1 to 6 °C, or from 2 to 5 °C.

Step (c)—Solidifying the Mixture Obtained in Step (b)

The re-melted mixture obtained in step (b) is further solidified by cooling. In the mixture obtained in step c), solids are present in an amount of from 10 to 40 wt. %, or preferably from 15 to 28 wt. % based on the total weight of the palm oil starting material (i.e., not including the weight of the solvent).

Preferably, the solidification in step c) can be done by cooling. In a preferred aspect, cooling can be done in a batch crystallizer that is cooled by vacuum-evaporation of solvent at a pressure in a range of from 125 to 600 mbar. Preferably, the pressure can be reduced in three stages: in the first stage, the pressure is reduced to between 400 and 600 mbar; in the second stage, the pressure is reduced to between 100 and 300 mbar; and in the final stage, the pressure is reduced to between 120 and 150 mbar.

In another preferred aspect, cooling in step c) can be done in a double jacketed cooling vessel with scraped surface (also known as scraped surface heat exchanger) or without scraped surface.

After solidification, the mixture obtained in step c) is at a temperature of from 5 to 10 °C, from 6 to 9 °C, or from 6.5 to 8.5 °C.

Step (d)—Separating the Mixture Obtained in Step (c) into a Solid Fraction and a Liquid Fraction

The mixture obtained in step (c) is separated into a solid fraction and a liquid fraction in step (d). Separation can be done in apparatus such as a vacuum belt filter or a membrane filter press.

Preferably, solvent can be recovered from the solid fraction and/or the liquid fraction; more preferably, the recovered solvent can be recycled into step (a).

Preferably, the solid fraction obtained in step (d) is a hard palm mid fraction (PMF) that has an IV of from 31 to 38, preferably from 32 to 37, more preferably from 33 to 36. The hard PMF can have:
a content of tripalmitoylglycerol (PPP) of less than 6 wt. %, preferably less than 5 wt. %, more preferably less than 4 wt. %, or more preferably from 2.5 to 4.0 wt. %;
a content of 1,3-dipalmitoyl-2-oleoyl-glycerol (POP) of greater than 60 wt. %, preferably greater than 63 wt. %, or more preferably greater than 65 wt. %; and
a content of 1,2-dioleoyl-3-palmitoyl-glycerol (POO) of less than 7 wt. %, preferably less than 5 wt. %, or more preferably less than 4.5 wt. %.

### Additional Process Steps

In a preferred aspect, the process of the present disclosure may comprise one or more steps before, or after step (a) to step (d).

Preferably, steps (b) and (c) may be repeated once or more prior to step (d). This will contribute to an even better quality of the obtained hard PMF. It relates to a process a process for producing a palm oil product, which comprises:
a) solidifying a palm oil starting material in the presence of a solvent, and obtaining a mixture comprising solvent and solids of the palm oil starting material;
b) partially re-melting the mixture obtained in step a);
c) solidifying the mixture obtained in step b); and
d) partially re-melting the mixture obtained in step c);
e) solidifying the mixture obtained in step d); and
f) separating the mixture obtained in step e) into a solid fraction and a liquid fraction, wherein
   after the solidification step a) the slurry of solids of the partially solidified mixture from step a) is at a temperature range of the mixture obtained in step a) is from 7 to 12 °C;
   after partially re-melting, the mixture obtained in step (b) is at a the temperature range of the mixture obtained in step b) is from 10 to 16 °C;
   after solidification, the mixture obtained in step c) is at a temperature range of the mixture obtained in step c) is from 5 to 10 °C.

Palm oil starting material may be treated prior to step (a) of the present inventive process. This pre-treatment may be by means of one or more refining steps such as degumming, bleaching, and/or deodorization. The palm oil starting material is preferably a degummed, bleached, and/or deodorized palm oil starting material.

### Effects of the Process

The process of the present disclosure for obtaining a hard palm mid fraction with IV in a range of from 31 to 38, preferably from 32 to 37, more preferably from 33 to 36, may result in a reduction of the amount of process steps required, and/or a reduction of the processing time.

### Single Process Step

Without being bound by any theory, the process according to the present invention may allow for a promotion of formation of desired symmetrical crystals (POP) while the formation of undesired asymmetrical triglycerides, such as POO, is reduced, and that may contribute to the desirable quality of the resulting hard PMF. As a result, by using the process of the present disclosure, a desired hard PMF can be achieved with a single process step as compared to conventional processes that involve several fractionation steps.

With the process of the present invention, only one co-fraction is generated as compared to the multiple co-fractions generated from the multiple fractionation steps in conventional processes.

Further, the entire process can happen in just one reactor without one or multiple transfer(s) of the process materials as in conventional processes; thus, the risk of material loss during transfer can be minimized or even avoided.

### Shorter Production Time

Process time of the present inventive process is about 2.5 hours, while dry fractionation in the conventional processes use 10 hours or more. Thus, process time may be saved for at least 75% with the present inventive process.

### Products Obtained by the Process

The present disclosure also relates to the products that are directly obtained by the process of the invention. In particular, the present disclosure relates to a hard palm mid fraction (PMF) obtainable by the present process.

In a preferred aspect, when palm olein IV56 is used as the palm oil starting material, the hard PMF obtained as the solid fraction after separation in step (d) has an iodine value of from 31 to 38, preferably from 32 to 37, more preferably from 33 to 36. The hard PMF obtained as the solid fraction after separation in step (d) has the following triglyceride contents:
a content of tripalmitoylglycerol (PPP) of less than 6 wt. %, preferably less than 5 wt. %, more preferably less than 4 wt. %, or more preferably from 2.5 to 4.0 wt. %;
a content of 1,3-dipalmitoyl-2-oleoyl-glycerol (POP) of greater than 60 wt. %, preferably greater than 63 wt. %, or more preferably greater than 65 wt. %; and
a content of 1,2-dioleoyl-3-palmitoyl-glycerol (POO) of less than 7 wt. %, preferably less than 5 wt. %, or more preferably less than 4.5 wt. %.

The hard PMF obtained as the solid fraction after separation in step (d) has a solid fat content (SFC), measured according to IUPAC method 2.150b:
at 20 °C, of more than 82%, preferably in a range of from 82.0 to 87.0%, more preferably from 83.0 to 86.0%, most preferably from 84.0 to 85.0%
at 35 °C, of less than 6%, preferably in a range of from 0.0 to 5.0%, more preferably from 0.0 to 4.0%, most preferably from 0.0 to 3.0%.

The liquid (olein) fraction that is obtained after removal of the solvent by the present process is also a useful product. Preferably, the palm oil olein that is obtained by the process of the invention as the liquid fraction after separation in step (d), and after removal of solvent, has an IV of from 60 to 70, preferably an IV of from 62 to 68, more preferably an IV of from 64 to 66.

### End Application of the Products Obtained by the Process

The hard PMF obtained by the process of the present disclosure can be used in various applications, including but not limited to, producing cocoa butter equivalents (CBE) or any other food application.

With its solid fat content (SFC) profile, the hard PMF obtained by the present inventive process gives sharp melting and clean mouthfeel that are especially desirable in confectionary applications. The hard PMF is a POP-rich fat that makes it possible to blend with exotic fats such as shea butter, shea stearin, illipe butter, sal fat, mango kernel fat, kokum gurgi fat or combinations or two or more thereof. The resulting blend, i.e; a cocoa butter equivalent, can achieve a 100% compatibility with cocoa butter without changing the characteristics of the final products.

### EXAMPLES

The invention is further described in detail by reference to the following experimental examples. These examples are provided for purposes of illustration only and are not intended to be limiting unless otherwise specified. Thus, the invention should in no way be construed as being limited to the following examples, but rather should be construed to encompass any and all variations which become evident as a result of the teaching provided herein.

### Example 1

### Materials and Method

Step (a)—Solidifying Palm Oil Starting Material in the Presence of a Solvent and Obtaining a Mixture Comprising Solvent and Solids of Palm Oil Starting Material:

Palm olein having an iodine value (IV) of 56 (Palm olein IV56), with solid fat contents (SFC) and triglyceride composition as shown in Table 3, was used as the starting material and cooled to 20 to 25 °C in a pre-cooler. The cooled palm olein IV56 and acetone were fed into a crystallizer in a ratio palm olein/acetone of 1/1. The mixture of the palm olein IV56 and acetone was partially solidified by evaporative cooling at a reduced pressure of from 125 to 145 mbar. The mixture at the end of step a) had a temperature of 8.5-10.5 °C. The mixture at the end of step a) had a content of 37 wt. % of solids. The amount of solids was determined by separating liquid and solid fraction by means of filtration and subsequently weighing both fractions.

TABLE 3

| Attributes | Palm olein IV56 |
|---|---|
| IV - according to Wijs method | 56.3 |
| (AOCS method Cd1-25) | |

Solid Fat Content - according to standard method of IUPAC 2.150a

| | |
|---|---|
| N10 | 30.8% |
| N20 | 4.2% |
| N25 | 0.0% |

Triglyceride composition - according to AOCS Ce5-86 method

| | |
|---|---|
| Tripalmitoylglycerol (PPP) | 0.9 wt. % |
| 1,3-dipalmitoyl-2-oleoyl-glycerol (POP) | 30.9 wt. % |
| 1,2-dioleoyl-3-palmitoyl-glycerol (POO) | 26.0 wt. % |

Step (b)—Partially Re-Melting the Mixture Obtained in Step (a):

Warm acetone at a temperature of about 35 °C was added to the crystallizer to heat up and re-melt the partially solidified mixture. The mixture at the end of step b) had a temperature of 12.5 °C. The mixture at the end of step b) contained 13.9 wt. % of solids (i.e. not including the weight of the solvent), which is a reduction of 62 wt % of solids, still remaining 38 wt % of solids.

Step (c)—Solidifying the Mixture Obtained in Step (b):

The mixture obtained in step c) was further solidified in the crystallizer by evaporative cooling at a reduced pressure of from 125 to 145 mbar. The mixture at the end of step c) had a temperature of 7.2 °C. The mixture at the end of step c) contained about 15.5 to 16 wt. % of solids (i.e. not including the weight of the solvent).

Step (d)—Separating the Mixture Obtained in Step (c) into a Solid Fraction and a Liquid Fraction:

Upon completion of solidification, the solidified mixture was transferred to a belt filter to separate the mixture obtained in step c) into a solid fraction and a liquid fraction. After acetone was removed from the solid by distillation, hard PMF was obtained. The recovered acetone was recycled back to the crystallizer.

### Hard PMF Obtained

The yield, IV, solid fat contents (SFC) and triglyceride composition of hard PMF obtained from 2 production trials according to the process of the present disclosure are shown in Table 4.

TABLE 4

| | Production | Production |
|---|---|---|
| Attributes | trial 1 | trial 2 |
| Hard PMF Yield (%) | 15.47 | 15.96 |
| IV - according to Wijs method | 33.8 | 33.7 |
| (AOCS method Cd1-25) | | |

Solid Fat Content - according to IUPAC method 2.150b

| | | |
|---|---|---|
| N10 | 92.5% | 91.5% |
| N20 | 85.0% | 84.6% |
| N25 | 74.0% | 74.6% |
| N30 | 46.8% | 46.5% |
| N35 | 5.7% | 4.9% |

Triglyceride composition - according to AOCS Ce5-86 method

| | | |
|---|---|---|
| 1,3-dipalmitoyl-2-oleoyl-glycerol (POP) | 66.3 wt. % | 65.8 wt. % |
| 1,2-dioleoyl-3-palmitoyl-glycerol (POO) | 4.2 wt. % | 4.4 wt. % |
| Tripalmitoylglycerol (PPP) | 3.9 wt. % | 3.8 wt. % |

1. A process for producing a palm oil product, which comprises:
a) solidifying a palm oil starting material in the presence of a solvent, and obtaining a mixture comprising solvent and solids of the palm oil starting material;
b) partially re-melting the mixture obtained in step a);
c) solidifying the mixture obtained in step b); and
d) separating the mixture obtained in step c) into a solid fraction and a liquid fraction; and
wherein
after the solidification step a) the slurry of solids of the partially solidified mixture from step a) is at a temperature range of the mixture obtained in step a) is from 7 to 12 °C;
after partially re-melting, the mixture obtained in step (b) is at a the temperature range of the mixture obtained in step b) is from 10 to 16 °C;
after solidification, the mixture obtained in step c) is at a temperature range of the mixture obtained in step c) is from 5 to 10 °C.

2. The process according to claim 1, wherein the solids content of the mixture at the end of step (b) is reduced by a range of from 40 to 80 wt %, preferably from 50 to 75%, more preferably from 55 to 70% as compared to the amount of solids present in the mixture at the end of step (a) due to partial remelting in step b).

3. The process according to claim 1, wherein in the partially solidified mixture from step a), solid fat is present in an amount from 12 to 70 wt. %, preferably from 20 to 50 wt. %, more preferably from 30 to 40 wt. % based on the total weight of the palm oil starting material, not including the weight of the solvent.

4. The process according to claim 1, wherein the palm oil starting material is palm oil or palm oil fraction, preferably the palm oil fraction is palm oil olein.

5. The process according to claim 1, wherein the palm oil starting material is palm oil olein with an iodine value (IV) of from 55 to 58, preferably of 56.

6. The process according to claim 1, wherein in step a) the palm oil starting material is mixed with the solvent in a weight ratio of palm oil starting material/solvent in a range of from 1/4 to 1/0.5.

7. The process according to claim 1, wherein the mixture in step a) comprises from 12 to 70 wt. % solids based on the total weight of the palm oil starting material.

8. The process according to claim 1, wherein the mixture in step b) comprises from 2.4 to 42 wt. % solids based on the total weight of the palm oil starting material.

9. The process according to claim 1, wherein the solidified re-melted mixture in step c) comprises from 10 to 40 wt. % solids.

10. The process according to claim 1, wherein the temperature difference of the mixture obtained in step b) and the mixture obtained in step a) is from 0.5 to 10 °C.

11. A process for producing a palm oil product, which comprises:
a) solidifying a palm oil starting material in the presence of a solvent, and obtaining a mixture comprising solvent and solids of the palm oil starting material;
b) partially re-melting the mixture obtained in step a);
c) solidifying the mixture obtained in step b); and
d) partially re-melting the mixture obtained in step c);
e) solidifying the mixture obtained in step d); and
f) separating the mixture obtained in step e) into a solid fraction and a liquid fraction, wherein
after the solidification step a) the slurry of solids of the partially solidified mixture from step a) is at a temperature range of the mixture obtained in step a) is from 7 to 12 °C;
after partially re-melting, the mixture obtained in step (b) is at a the temperature range of the mixture obtained in step b) is from 10 to 16 °C;
after solidification, the mixture obtained in step c) is at a temperature range of the mixture obtained in step c) is from 5 to 10 °C.

12. The process according to claim 11, wherein solvent is recovered from the solid and/or liquid fraction from step d) and preferably recycled into step a).

13. The process according to claim 11, wherein after separating the mixture of step c) or e), a solid fraction of a hard palm mid fraction having an iodine value in a range of from 31 to 38 is collected.

14. The process according to claim 11, wherein after separating the mixture of step c) or e), a solid fraction of a hard palm mid fraction is collected and the hard palm mid fraction is having:
a content of tripalmitoylglycerol (PPP) of from 2.5 to 6 wt. %, a content of 1,3-dipalmitoyl-2-oleoyl-glycerol (POP) of greater than 63 wt. %, and a content of 1,2-dioleoyl-3-palmitoyl-glycerol (POO) of less than 5 wt. %; and/or
a solid fat content at 20 °C in a range of from 82.0 to 87.0%, and a solid fat content at 35 °C in a range of from 0.0 to 5.0%, measured according to IUPAC method 2.150b.
